(19) United States
(12) Patent Application Publication
(10) Pub. No.: US 2013/0100925 A1
(43) Pub. Date: Apr. 25, 2013

(54) APPARATUS AND METHOD FOR TRANSMITTING INFORMATION ON POWER HEADROOM IN MULTIPLE COMPONENT CARRIER SYSTEM

(71) Applicants: Jae Hyun Ahn, Seoul (KR); Ki Bum Kwon, Seoul (KR)

(72) Inventors: Jae Hyun Ahn, Seoul (KR); Ki Bum Kwon, Seoul (KR)

(73) Assignee: Pantech Co. Ltd., Seoul (KR)

(21) Appl. No.: 13/807,691

(22) PCT Filed: Aug. 22, 2011
(86) PCT No.: PCT/KR2011/006171

§ 371 Date: Dec. 28, 2012

(30) Foreign Application Priority Data
Aug. 24, 2010 (KR) 10-2010-0082191

(51) Int. Cl. H04W 52/36

(52) U.S. Cl. CPC H04W 52/365
USPC 370/329

(57) ABSTRACT

There are provided an apparatus and method for transmitting power headroom information in a multiple component carrier system. This specification discloses a configuration in which a user equipment (UE) receives a Combination Power Headroom Report (CPHR) request message, including a combination indication field indicative of a combination including a plurality of component carriers, from a eNodeB (eNB), calculates a Combination Power Headroom (CPH) calculated in the UE-specific way for the plurality of component carriers, and sends the CPH to the eNB. Accordingly, the complexity of a power headroom report by an UE can be reduced and radio resources used in the power headroom report can be reduced, with the result that uplink transmission performance can be reduced. Furthermore, a scheduler can per form reliable dynamic uplink scheduling in a system to which a carrier aggregation is applied.

### CROSS-REFERENCE TO RELATED APPLICATIONS

This Application is the National Stage Entry of International Application No. PCT/KR2011/006171, filed on Aug. 22, 2011, and claims priority from and the benefit of Korean Patent Application No. 10-2010-0082191, filed on Aug. 24, 2010, all of which are incorporated herein by reference for all purposes as if fully set forth herein.

### BACKGROUND

1. Field

The present invention relates to wireless communication, and more particularly, to an apparatus and method for transmitting information about power headroom in a multiple component carrier system.

2. Discussion of the Background

A wireless communication system uses one bandwidth for data transmission. For example, the 2^{nd} generation wireless communication system uses a bandwidth of 200 KHz to 1.25 MHz, and the 3^{rd} generation wireless communication system uses a bandwidth of 5 MHz to 10 MHz. In order to support an increasing transmission capacity, the bandwidth of a recent 3GPP LTE or 802.16m has extended to 20 MHz or higher. To increase the bandwidth may be considered to be indispensable so as to increase the transmission capacity, but to support a high bandwidth even when the quality of service required is low may generate great power consumption.

For the above region, there has emerged a multiple component carrier system in which a component carrier having one bandwidth and the center frequency is defined and data is transmitted or received through a plurality of component carriers using a wide band. That is, a narrow band and a wide band are supported at the same time by using one or more component carriers. For example, if one component carrier corresponds to a bandwidth of 5 MHz, a maximum 20 MHz bandwidth can be supported by using four component carriers.

A method of a base station efficiently using the resources of a mobile station is to use power headroom information provided by the user equipment. The power headroom information is essential information for efficiently allocating uplink resources in wireless communication and reducing the battery consumption of a user equipment. When the user equipment provides the power headroom information to the base station, the base station can estimate maximum transmission power in uplink that the user equipment can withstand. Accordingly, the base station can perform uplink scheduling within a range in which the estimated maximum transmission power in uplink is not exceed.

Power headroom for each component carrier has a relatively small variance. Meanwhile, when a plurality of component carriers is dynamically scheduled, the variance may become relatively high. For this reason, the power headrooms of component carriers must be taken into account individually or overall.

### SUMMARY

An object of the present invention is to provide an apparatus and method for transmitting Combination Power Headroom (CPH) information.

Another object of the present invention is to provide an apparatus and method for receiving CPH information.

Yet another object of the present invention is to provide an apparatus and method for generating a CPH report request message to request a CPH report.

Further yet another object of the present invention is to provide an apparatus and method for performing dynamic uplink scheduling using CPH information.

Further yet another object of the present invention is to provide an apparatus and method for requesting a CPH report.

Further yet another object of the present invention is to provide a signaling apparatus and method for requesting a CPH report.

Further yet another object of the present invention is to provide an apparatus and method for triggering a CPH report.

According to an aspect of the present invention, there is provided a method of a user equipment (UE) sending power headroom information in a multiple component carrier system. The method includes receiving a Combination Power Headroom Report (CPHR) request message, including a combination indication field indicative of a combination including a plurality of component carriers, from a eNodeB (eNB), calculating a CPH of power headrooms calculated in the UE-specific way upon uplink transmission through the plurality of component carriers, generating CPH information used to inform the eNB of the CPH, and sending the CPH information to the eNB.

According to another aspect of the present invention, there is provided a method of an eNB receiving power headroom information in a multiple component carrier system. The method includes sending a Combination Power Headroom Report (CPHR) request message, including a combination indication field, to an UE and receiving CPH information, informing a CPH, from the UE.

The combination indication field indicates a combination including a plurality of component carriers. The CPH is calculated in the UE-specific way upon uplink transmission through the plurality of component carriers.

According to yet another aspect of the present invention, there is provided an apparatus for transmitting power headroom information in a multiple component carrier system. The apparatus includes a message reception unit for receiving a Combination Power Headroom Report (CPHR) request message, including a combination indication field indicative of a combination including a plurality of component carriers, from an eNB, a CPH calculation unit for calculating a CPH of power headrooms which are calculated upon uplink transmission through the plurality of component carriers, and a message transmission unit for sending CPH information indicative of the CPH.

According to further yet another aspect of the present invention, there is provided an apparatus for receiving power headroom information in a multiple component carrier system. The apparatus includes a combination generation unit for generating a combination including a plurality of component carriers, a triggering unit for determining whether a triggering condition to induce a report request for a CPH regarding the combination is satisfied, a message transmission unit for, if the triggering condition is satisfied, sending a Combination Power Headroom Report (CPHR) request message, requesting a CPH report on the combination, to an UE, a message reception unit for receiving CPH information indicative of the CPH from the UE, and an uplink scheduler for performing dynamic uplink scheduling regarding the UE based on the CPH information.

The CPH is calculated in the UE-specific way upon uplink transmission through the plurality of component carriers, and the CPHR request message includes a combination indication field indicative of the combination.

In accordance with the present invention, when an eNB requests CPH information from an UE based on information indicating a specific combination of component carriers in a wireless communication system in which a carrier aggregation is used, the UE sends the CPH information about the specific combination of component carriers, indicated by the eNB, to the eNB. Accordingly, the complexity of a CPH report can be reduced and radio resources used in the CPH report can be reduced, with the result that uplink transmission performance can be improved. Consequently, reliable dynamic uplink scheduling can be induced in a system to which a carrier aggregation is applied.

### BRIEF DESCRIPTION OF THE DRAWINGS

FIG. 1 is shows a wireless communication system;

FIG. 2 is an explanatory diagram illustrating an intra-band contiguous carrier aggregation;

FIG. 3 is an explanatory diagram illustrating an intra-band non-contiguous carrier aggregation;

FIG. 4 is an explanatory diagram illustrating an inter-band carrier aggregation;

FIG. 5 shows a linkage between a DL CC (downlink component carrier) and a UL CC (uplink component carrier) in a multiple carrier system;

FIG. 6 is a graph shows another example of power headroom to which the present invention is applied in the time-frequency axis;

FIG. 7 is an explanatory diagram illustrating the concept of CPH according to an embodiment of the present invention;

FIG. 8 is a flowchart illustrating a method of transmitting CPH information according to an embodiment of the present invention;

FIG. 9 is a flowchart illustrating an eNB triggering a report request according to an embodiment of the present invention;

FIG. 10 is a flowchart illustrating an eNB triggering a report request according to another embodiment of the present invention;

FIG. 11 is a flowchart illustrating an eNB triggering a report request according to yet another embodiment of the present invention;

FIG. 12 is a flowchart illustrating an eNB triggering a report request according to further yet another embodiment of the present invention;

FIG. 13 is a diagram showing a combination CC indication field according to an embodiment of the present invention;

FIG. 14 is a diagram showing a combination CC indication field according to another embodiment of the present invention;

FIG. 15 shows the architecture of an MAC PDU including a CPHR request message according to an embodiment of the present invention;

FIG. 16 shows the architecture of an MAC PDU including a CPHR request message according to another embodiment of the present invention;

FIG. 17 shows the architecture of an MAC PDU including a CPHR request message according to yet another embodiment of the present invention the;

FIG. 18 is a block diagram showing an MAC PDU including CPH information according to an embodiment of the present invention; and

FIG. 19 is a block diagram showing an apparatus for transmitting and receiving CPH information according to an embodiment of the present invention.

### DETAILED DESCRIPTION OF THE ILLUSTRATED EMBODIMENTS

Hereinafter, in this specification, some embodiments of the present invention will be described in detail with reference to some exemplary drawings. It is to be noted that in assigning reference numerals to respective elements in the drawings, the same reference numerals designate the same elements although the elements are shown in different drawings. Furthermore, in describing the present invention, a detailed description of the known functions and constructions will be omitted if it is deemed to make the gist of the present invention unnecessarily vague.

Furthermore, in describing the elements of this specification, terms, such as the first, second, A, B, a, and b, may be used. However, the terms are used to only distinguish one element from the other element, but the essence, order, and sequence of the elements are not limited by the terms. Furthermore, in the case in which one element is described to be “connected”, “coupled”, or “jointed” to the other element, the one element may be directly connected or coupled to the other element, but it should be understood that a third element may be “connected”, “coupled”, or “jointed” between the two elements.

Furthermore, in this specification, a wireless communication network is chiefly described. Tasks performed in the wireless communication network may be performed in a process of a system (for example, a base station), managing the wireless communication network, control the network and transmitting data or may be performed by a mobile station coupled to the network.

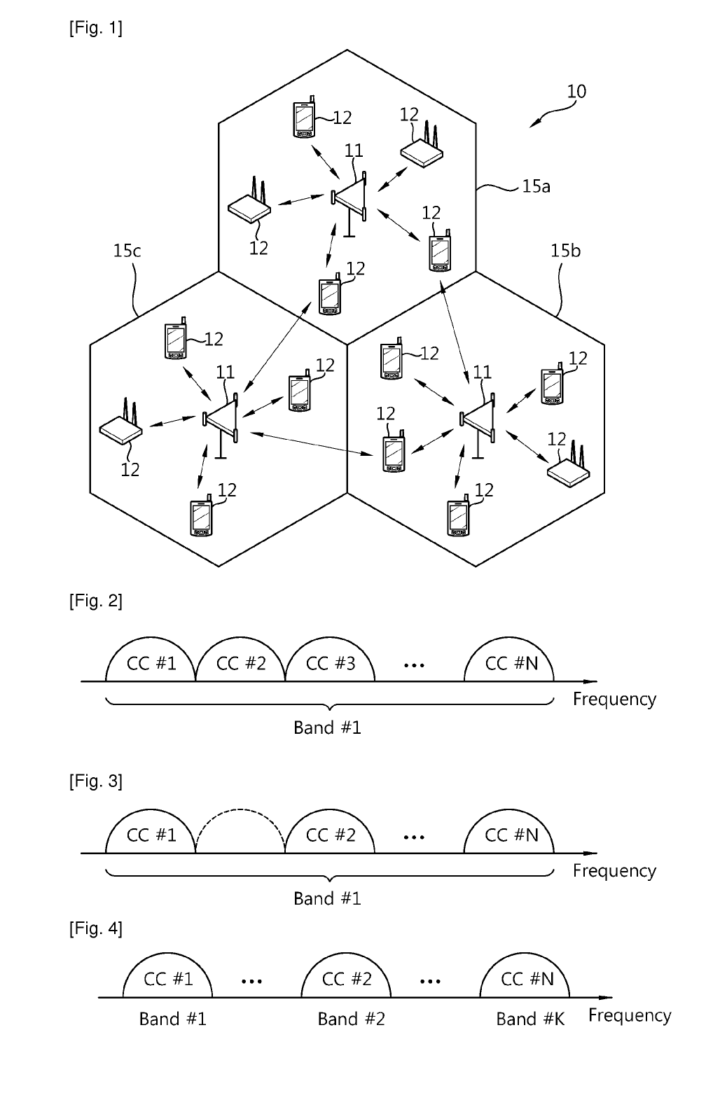

FIG. 1 is shows a wireless communication system.

Referring to FIG. 1, the wireless communication systems 10 are widely deployed in order to provide a variety of communication services, such as voice and packet data. The wireless communication system 10 includes one or more eNodeB (eNB) 11. Each eNB 11 provides communication services to specific geographical areas (typically called cells 15a, 15b, and 15c). The cell may be classified into a plurality of areas (called a sector).

A user equipment (UE) 12 may be fixed or mobile and may also be called another terminology, such as MS (Mobile Station), an MT (Mobile Terminal), a UT (User Terminal), an SS (Subscriber Station), a wireless device, a PDA (Personal Digital Assistant), a wireless modem, or a handheld device.

The eNB (evolved NodeB: eNodeB) 11 refers to a fixed station communicating with the UE 12, and it may also be called another terminology, such as Base Station (BS), a BTS (Base Transceiver System), or an access point. The cell should be interpreted as a comprehensive meaning indicating some areas covered by the eNB 11, and it has a meaning to comprehensively cover various coverage areas, such as a mega cell, a macro cell, a micro cell, a pico cell, and a femto cell.

Hereinafter, downlink (DL) refers to communication from the eNB 11 to the UE 12, and uplink (UL) refers to communication from the UE 12 to the eNB 11. In downlink, a transmitter may be a part of the eNB 11, and a receiver may be a part of the UE 12.

In uplink, a transmitter may be a part of the UE 12, and a receiver may be a part of the eNB 11.

There are no limits to multiple access schemes applied to the wireless communication system. A variety of multiple access schemes, such as CDMA (Code Division Multiple Access), TDMA (Time Division Multiple Access), FDMA (Frequency Division Multiple Access), OFDMA (Orthogonal Frequency Division Multiple Access), SC-FDMA (Single Carrier-FDMA), OFDM-FDMA, OFDM-TDMA, and OFDM-CDMA, may be used. For uplink and downlink transmission, Time Division Duplex (TDD) method which transmit using different time may used, or Frequency Division Duplex (FDD) method which transmit using different frequency may used.

The layers of a radio interface protocol between an UE and a network may be classified into a first layer L1, a second layer L2, and a third layer L3 on the basis of three lower layers of an Open System Interconnection (OSI) which has been widely known in the communication systems.

A physical layer (i.e., the first layer) is connected to a higher Medium Access Control (MAC) layer through a transport channel. Data between the MAC layer and the physical layer is moved through the transport channel. Furthermore, data between different physical layer (i.e., the physical layers on the transmission side and on the reception side) is moved through a physical channel. There are some control channels used in the physical layer.

A Physical Downlink Control Channel (PDCCH) through which physical control information is transmitted informs an UE of the resource allocation of a PCH (paging channel) and a downlink shared channel (DL-SCH) and Hybrid Automatic Repeat Request (HARQ) information related to the DL-SCH. The PDCCH may carry an uplink grant, informing an UE of the allocation of resources for uplink transmission. A Physical Control Format Indicator Channel (PCFICH) is used to inform an UE of the number of OFDM symbols used in the PDCCHs and is transmitted every frame. A Physical Hybrid ARQ Indicator Channel (PHICH) carries HARQ ACK/NAK signals in response to uplink transmission. A Physical Uplink Control Channel (PUCCH) carries HARQ ACK/NAK signals for downlink transmission, a scheduling request, and uplink control information, such as a Channel Quality Indicator (CQI). A Physical Uplink Shared Channel (PUSCH) carries a uplink shared channel(UL-SCH).

A situation in which an UE sends a PUCCH or a PUSCH is as follows.

An UE configures a PUCCH for one or more pieces of CQI (Channel Quality Information) and pieces of information about a PMI (Precoding Matrix Index) selected based on measured space channel information, and information about a RI (Rank Indicator) and periodically sends the configure PUCCH to an eNB. Furthermore, the UE receives downlink data from the eNB and must send ACK/NACK (Acknowledgement/non-Acknowledgement) information about the downlink data to the eNB after a certain number of subframes.

For example, if downlink data is received in an n^{th} subframe, the UE sends a PUCCH, composed of ACK/NACK information about the downlink data, in an (n+1)^{th} subframe. If ACK/NACK information cannot be all transmitted on a PUCCH allocated by the eNB or if a PUCCH on which ACK/NACK information can be transmitted is not allocated by the eNB, the UE may carry the ACK/NACK information on a PUSCH.

A radio data link layer (i.e., the second layer) includes an MAC layer, an RLC layer, and a PDCP layer. The MAC layer is a layer responsible for mapping between a logical channel and a transport channel. The MAC layer selects a proper transport channel suitable for sending data received from the RLC layer and adds necessary control information to the header of an MAC Protocol Data Unit (PDU). The RLC layer is placed over the MAC layer and configured to support reliable data transmission.

Furthermore, the RLC layer segments and concatenates RLC Service Data Units (SDUs) received from a higher layer in order to configure data having a size suitable for a radio section. The RLC layer of a receiver supports a data reassembly function for recovering original RLC SDUs from received RLC PDUs. The PDCP layer is used only in a packet exchange region, and it can compress and send the header of an IP packet in order to increase the transmission efficiency of packet data in a radio channel.

An RRC layer (i.e., the 3^{rd} layer) functions to control a lower layer and also to exchange pieces of radio resource control information between an UE and a network. A variety of RRC states, such as an idle mode and an RRC connected mode, are defined according to the communication state of an UE. An UE may transfer between the RRC states, if necessary. Various procedures related to the management of radio resources, such as system information broadcasting, an RRC access management procedure, a multiple component carrier configuration procedure, a radio bearer control procedure, a security procedure, a measurement procedure, and a mobility management procedure (handover), are defined in the RRC layer.

A carrier aggregation (CA) supports a plurality of carriers. The carrier aggregation is also called a spectrum aggregation or a bandwidth aggregation. Individual unit carriers aggregated by a carrier aggregation are called a Component Carrier (CC). Each CC is defined by the bandwidth and the center frequency. The carrier aggregation is introduced in order to support an increased throughput, prevent an increase of the expenses due to the introduction of a Radio Frequency (RF) device, and guarantee compatibility with the existing system. For example, if five CCs are allocated as the granularity of a carrier unit having a 5 MHz bandwidth, the bandwidth of a maximum of 25 MHz can be supported.

CCs may be divided into a primary CC (hereinafter referred to as a PCC) and a secondary CC (hereinafter referred to as an SCC) according to whether they have been activated. The PCC is a carrier that is always activated, and the SCC is a carrier that is activated or deactivated according to a specific condition. Activation means that the transmission or reception of traffic data is being performed or in a standby state. Deactivation means that the transmission or reception of traffic data is impossible, but measurement or the transmission/reception of minimum information is possible. An UE may use only one PCC and one or more SCCs along with a PCC. An eNB may allocate the PCC or the SCC or both to an UE.

The carrier aggregation may be classified into an intra-band contiguous carrier aggregation, such as that shown in FIG. 2, an intra-band non-contiguous carrier aggregation, such as that shown in FIG. 3, and an inter-band carrier aggregation, such as that shown in FIG. 4.

Referring to FIG. 2, the intra-band contiguous carrier aggregation is formed within intra-band continuous CCs. For example, aggregated CCs, that is, a CC #1, a CC #2, a CC #3 to a CC #N are contiguous to each other.

Referring to FIG. 3, the intra-band non-contiguous carrier aggregation is formed between discontinuous CCs. For example, aggregated CCs, that is, a CC #1 and a CC #2 are spaced apart from each other by a specific frequency.

Referring to FIG. 4, the inter-band carrier aggregation is of a type in which, when a plurality of CCs exists, one or more of the CCs are aggregated on different frequency bands. For example, an aggregated CC, that is, CC #1 exists in a band #1, and an aggregated CC, that is, a CC #2 exists in a band #2.

The number of carriers aggregated between downlink and uplink may be different. The case where the number of DL CCs is identical with the number of UL CCs is called a symmetric aggregation, and a case where the number of DL CCs is different from the number of UL CCs is called an asymmetric aggregation.

Furthermore, CCs may have different sizes (i.e., bandwidths). For example, assuming that 5 CCs are used to configure a 70 MHz band, the configuration may have a form, such as 5 MHz CC (carrier #0)+20 MHz CC (carrier #1)+20 MHz CC (carrier #2)+20 MHz CC (carrier #3)+5 MHz CC (carrier #4).

A multiple carrier system hereinafter refers to a system supporting the carrier aggregation. In the multiple carrier system, the contiguous carrier aggregation or the non-contiguous carrier aggregation or both may be used. Furthermore, either the symmetric aggregation or the asymmetric aggregation may be used.

FIG. 5 shows a linkage between a downlink component carrier (DL CC) and an uplink component carrier (UL CC) in a multiple carrier system.

Referring to FIG. 5, in downlink, Downlink Component Carriers (hereinafter referred to as t carrier (UL CC) in a multiple carrier system us carrier aggregation or the non-contiguous referred to as ‘UL CC’) U1, U2, and U3 are aggregated. Here, D1 is the index of a DL CC, and U1 is the index of a UL CC (where i=1, 2, 3). At least one DL CC is a PCC, and the remaining CCs are SCCs Likewise, at least one UL CC is a PCC, and the remaining CCs are SCC. For example, D1 and U1 may be PCCs, and D2, U2, D3, and U3 may be SCCs.

In an FDD system, a DL CC and a UL CC are linked to each other in a one-to-one manner. D1 and U1, D2 and U2, and D3 and U3 are linked to each other in a one-to-one manner. An UE sets up linkages between the DL CCs and the UL CCs based on system information transmitted on a logical channel BCCH or an UE-dedicated RRC message transmitted on a DCCH. Each linkage may be set up in a cell-specific way or an UE-specific way.

Only the 1:1 linkage between the DL CC and the UL CC has been illustrated in FIG. 5, but a 1:n or n:1 linkage may also be set up. Furthermore, the index of a component carrier does not comply with the sequence of the component carrier or the position of the frequency band of the component carrier.

Hereinafter, power headroom (PH) is described.

Power headroom means surplus power that may be additionally used other than power which is now being used by an UE for uplink transmission. For example, it is assumed that an UE has maximum transmission power of 10 W (i.e., uplink transmission power of an allowable range). It is also assumed that the UE is now using power of 9 W in the frequency band of 10 MHz. In this case, power headroom is 1 W because the UE can additionally use power of 1 W.

Here, if an eNB allocates a frequency band of 20 MHz to the UE, power of 9 W9 Wpower of 9 Wer of 1 W.h is now being used by an UE for uplink transmission. For example, it is assumed that an UE hquency band because the UE has the maximum power of 10 W, or the eNB may not properly receive signals from the UE owing to the shortage of power. In order to solve this problem, the UE reports the power headroom of 1 W to the eNB so that the eNB can perform scheduling within a range of the power headroom. This report is called a Power Headroom Report (PHR). The power headroom P_{PH} may also be called the remaining power or surplus power. The reported power headroom may be given as in the following table.

TABLE 1

| Reported value | Measured quantity value (dB) |
|---|---|
| POWER_HEADROOM_0 | −23 ≦ PH < −22 |
| POWER_HEADROOM_1 | −22 ≦ PH < −21 |
| POWER_HEADROOM_2 | −21 ≦ PH < −20 |
| POWER_HEADROOM_3 | −20 ≦ PH < −19 |
| POWER_HEADROOM_4 | −19 ≦ PH < −18 |
| POWER_HEADROOM_5 | −18 ≦ PH < −17 |
| . . . | . . . |
| POWER_HEADROOM_57 | 34 ≦ PH < 35 |
| POWER_HEADROOM_58 | 35 ≦ PH < 36 |
| POWER_HEADROOM_59 | 36 ≦ PH < 37 |
| POWER_HEADROOM_60 | 37 ≦ PH < 38 |
| POWER_HEADROOM_61 | 38 ≦ PH < 39 |
| POWER_HEADROOM_62 | 39 ≦ PH < 40 |
| POWER_HEADROOM_63 | PH ≧ 40 |

Referring to Table 1, power headroom belongs to a range of −23 dB to +40 dB. If 6 bits are used to represent the power headroom, 2⁶(=64) kinds of indices can be represented. The power headroom is classified into a total of 64 levels. For example, if a bit to represent the power headroom is 0 (i.e., f a bit to represent t presented by 6 bits), the power headroom indicates “−23≦P_{PH}≦Hadroom

A periodic PHR method may be used because the power headroom is frequently changed. According to the periodic PHR method, when a periodic timer expires, an UE triggers a PHR. After reporting power headroom, the UE drives the periodic timer again.

Furthermore, when a Path Loss (PL) estimate measured by an UE exceeds a certain reference value, the PHR may be triggered. The PL estimate is measured by an UE on the basis of Reference Symbol Received Power (RSRP).

Power headroom P_{PH} is defined as a difference between a maximum transmission power Pₘₐₓ, configured in an UE, and a power P_{estimated} estimated in regard to uplink transmission as in Equation 1 and is represented by dB.

P_{PH}=Pₘₐₓ−P_{estimated}[dB] Math 1

That is, the remainder in which the estimated power P_{estimated} estimated (i.e., the sum of transmission power being used in each component carrier) has been subtracted from the maximum transmission power of an UE configured by an eNB becomes the power headroom P_{PH}.

For example, the estimated power P_{estimated} estimated is equal to power P_{PUSCH} estimated in regard to the transmission of a Physical Uplink Shared Channel (hereinafter referred to as a PUSCH). In this case, the power headroom P_{PH} can be obtained using Equation 2.

P_{PH}=Pₘₐₓ−P_{PUSCH}[dB] Math 2

For another example, the estimated power P_{estimated} estimated is equal to the sum of power P_{PUSCH} estimated in regard to the transmission of a PUSCH and power P_{PUCCH} estimated in regard to the transmission of a Physical Uplink Control Channel (hereinafter referred to as a PUCCH). In this case, the power headroom P_{PH} can be found by Equation 3.

P_{PH}=Pₘₐₓ−P_{PUCCH}−P_{PUSCH}[dB] Math 3

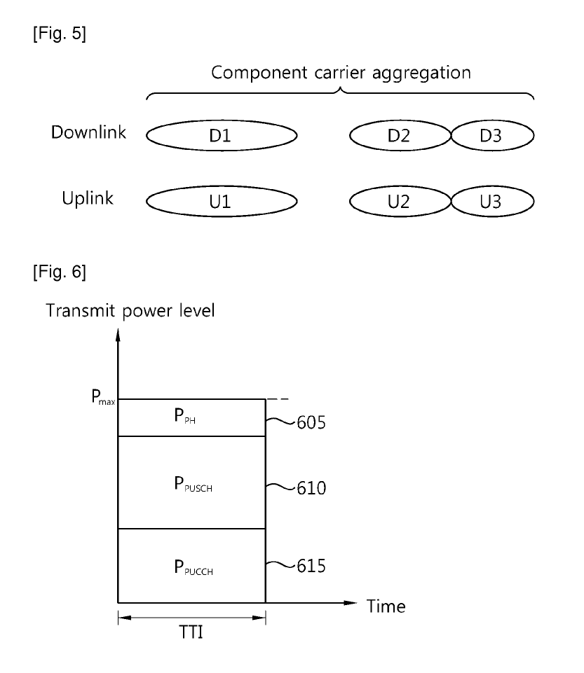

If the power headroom according to Equation 3 is represented by a graph in the time-frequency axis, it results in FIG. 6. FIG. 6 shows power headroom for one CC.

Referring to FIG. 6, the maximum transmission power Pₘₐₓ configured in an UE consists of P_{PH} 605, P_{PUSCH} 610, and P_{PUCCH} 615. That is, the remaining power in which the P_{PUSCH} 610 and the P_{PUCCH} 615 have been subtracted from Pₘₐₓ is defined as the P_{PH} 605. Each power is calculated for each Transmission Time Interval (TTI).

A primary serving cell is a unique serving cell which has a UL PCC capable of sending a PUCCH. Accordingly, since a secondary serving cell cannot send a PUCCH, parameters and an operation for a method of reporting the power headroom defined by Equation 2 and the power headroom defined by Equation 3 are not defined.

On the other hand, in a primary serving cell, parameters and an operation for a method of reporting the power headroom defined by Equation 3 may be defined. If an UE has to receive an uplink grant from an eNB, send a PUSCH in a primary serving cell, and simultaneously send a PUCCH in the same subframe according to a predetermined rule, the UE calculates all the power headrooms according to Equation 2 and Equation 3 when a power headroom report is triggered and sends them to an eNB.

In a multiple component carrier system, power headroom for each of a number of configured CCs may be defined.

Dynamic scheduling is used to schedule uplink scheduling through several combinations of CCs. Accordingly, uplink transmission can be performed at the same time through certain combinations of CCs. In this case, the reason why power headroom in which all the certain combinations of CCs are taken into consideration rather than the power headroom of each CC is that the maximum transmission power of each UE is dependent on power headroom in which combined CCs are taken into consideration. Accordingly, power headroom when uplink transmission is performed at the same time through a plurality of CCs under dynamic scheduling, as well as power headroom according to each CC as described above, must be taken into consideration.

To this end, IPH, CPH, IPH information, and CPH information are first defined.

The individual power headroom (IPH) refers to power headroom which is calculated in a CC-specific way when only uplink transmission of one CC configured in an UE is performed. Furthermore, the IPH information refers to a message of a certain format or control information which is used to inform an eNB of CPH. Furthermore, to report the IPH to an eNB is called an IPH Report (IPHR).

The combination power headroom (CPH) refers to power headroom which is calculated in an UE-specific way when uplink transmission through a certain combination of CCs configured in an UE is performed at the same time. Furthermore, the CPH information refers to a message of a certain format or control information which is used to inform an eNB of CPH.

Furthermore, to report an eNB to the CPH is called a CPH Report (CPHR). If uplink transmissions are performed at the same time through a combination {CC1, CC2}, a power headroom PH3 in which both the power headroom PH1 of the CC1 and the power headroom PH2 of the CC2 are incorporated becomes a CPH. A plurality of CCs becoming a cause to generate the CPH is called a Combination CC (CCC), and the number of combination CCs may be two or more.

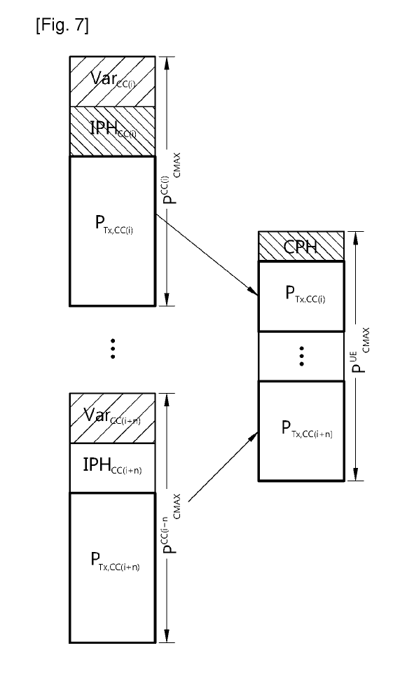

FIG. 7 is an explanatory diagram illustrating the concept of CPH according to an embodiment of the present invention.

Referring to FIG. 7, it is assumed that CCs configured in an UE are CC(i) to CC(i+n). The IPH of each CC is described below. A maximum transmission power PCC⁽ⁱ⁾_{CMAX} for the CC(i) is obtained according to Equation 4 below.

P_{CMAX}^{CC(i)}=Var_{CC(i)}+IPH_{CC(i)}+P_{Tx,CC(i)} Math 4

In Equation 4, Var_{CC(i)} is the variance of CC(i), IPH_{CC(i)} is the IPH of CC(i), and P_{Tx,CC(i)} is current uplink transmission power.

Next, a maximum transmission power P^{CC(i+n)}_{CMAX} for CC(i+n) is found by the following Equation.

P_{CMAX}^{CC(i+n)}=Var_{CC(i+n)}+IPH_{CC(i+n)}+P_{Tx,CC(i+n)} Math 5

Meanwhile, a maximum transmission power P^{UE}_{CMAX} regarding the combinations {CC(i) to CC(i+n)} is found by the following equation.

P_{CMAX}^{UE}=CPH+P_{Tx,CC(i)}+ . . . +P_{Tx,CC(i+n)} Math 6

Referring to Equation 6, CPH is CPH regarding the combination {CC(i) to CC(i+n)}, and P_{Tx,CC(i)} is the component of CC(i) constituting uplink transmission power.

In a situation in which a bandwidth, and MCS, and a path loss are the same, there is a significant difference between CPH and power headrooms IPH_{CC(i)} to IPH_{CC(i+n)} according to each CC for uplink transmission without distortion. If an eNB increases the bandwidth or raises the MCS level in regard to a relevant UE, the UE must set power of the intensity belonging to a region having severe distortion and perform uplink transmission. Such uplink transmission may become a cause to reduce reliability of a link and to greatly degrade the performance of a system. For this reason, CPH is required in order for an eNB to perform accurate dynamic scheduling in a multiple component carrier system.

In accordance with the present invention, whether an UE will report the CPH of what combination CC and will not report the CPH of what combination CC depends on the selection of an eNB. If it is determined that a report on a power headroom for a combination to which a specific CC belongs may waste uplink resources, an eNB may request, from an UE, only CPH information about combination CCs other than the combination to which the specific CC belongs. This is also combined with a report request triggering problem to be described later.

For example, if an eNB applies deactivation to a specific CC, a CPH report on a combination CC including the deactivated CC is not necessary. Accordingly, the eNB requests only a CPH report on a combination CC, not including the deactivated CC, from an UE.

For another example, if limited power is applied to a specific CC for Inter-Cell Interference Control (ICIC) in uplink, an eNB does not require a CPH report in a combination CC including the specific CC to which the limited power has been applied. Accordingly, the eNB requests only a CPH report on a combination CC, not including the specific CC to which the limited power has been applied, from an UE.

For yet another example, if only some of the configuration of a CC has been changed when an eNB reconfigures the CC, a CPH report all combination CCs is waste of resources. Accordingly, the eNB requests only a CPH report on a combination CC, including a CC having a changed configuration, from an UE.

That is, a CPH report is selectively performed only for a specific combination CC, and the specific combination CC is determined by an eNB. An UE is unable to know that an eNB wants a CPH report on what combination CC until the eNB lets the UE know the CPH report. Accordingly, a request of an eNB for a CPH report must be accompanied by a procedure of the eNB selecting a combination CC and informing the selected combination CC of an UE. In this case, the UE can send CPH information about the selected combination CC to the eNB.

Hereinafter, a procedure of sending CPH information is described.

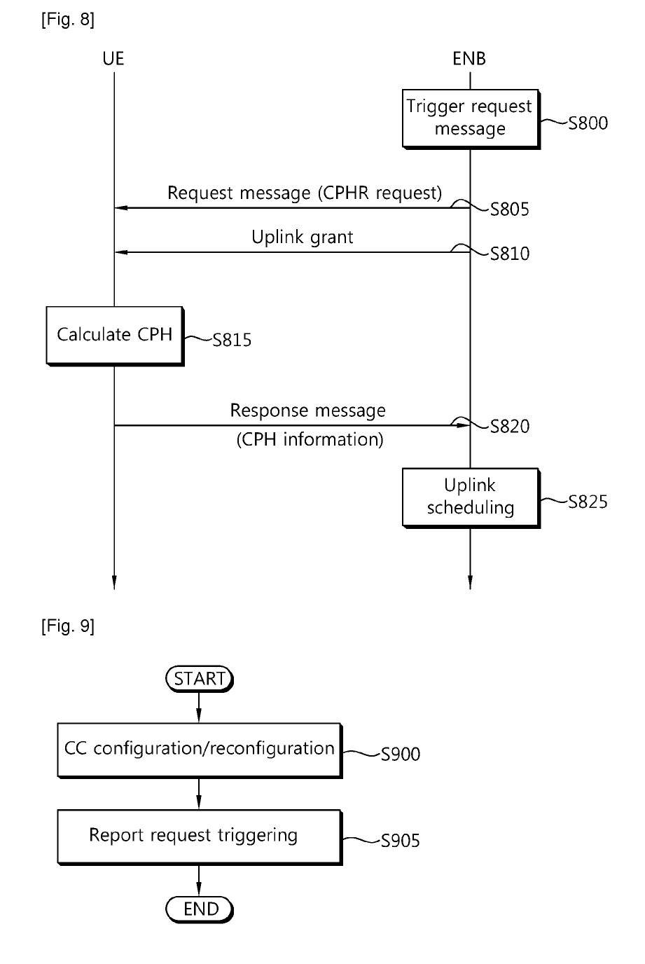

FIG. 8 is a flowchart illustrating a method of transmitting CPH information according to an embodiment of the present invention. A procedure of transmitting CPH information is initiated by an eNB.

Referring to FIG. 8, the eNB triggers a report request (RR) at step S800. The report request triggering refers to an operation of the eNB entering a state in which it can request a CPH report. When the report request is triggered, the eNB is prepared to request a CPH report. Triggering conditions may be various, and an eNB can continue to monitor whether a triggering condition is satisfied. The triggering conditions are described later.

The eNB sends a CPHR request message to an UE at step S805. The CPHR request message is a message including information for requesting that a power headroom report on CCs combined by an UE be made. The CPHR request message includes a Combination CC Indication Field (CCCIF) necessary for the eNB and indicative of combinable CCs.

The eNB sends an uplink grant for allocating uplink resources to be used in the power headroom report by the UE to the UE at step S810. An example of the uplink grant is shown in Table 2.

```
TABLE 2
Flag for format0/format1A differentiation—1 bit, where value 0
indicated format 0 and value 1 indicates format 1A
Frequency hopping flag—1 bit
Resource block assignment and hopping resource allocation—
[log₂{N_{RB}^{UL}(N_{RB}^{UL} + 1)/2)] bits
  For PUSCH hopping:
    N_{UL}_hop MSB bits are used to obtain the value ñ _{PRB} (i)
    ([log₂(N_{RB}^{UL}(N_{RB}^{UL} ÷ 1)/2)] − N_{UL}_hop) bits
    provide the resource allocation of the first slot in the UL subframe
  For non-hopping PUSCH:
    ([log₂(N_{RB}^{UL}(N_{RB}^{UL} ÷ 1)/2)]) bits provide the
    resource allocation in the UL subframe
Modulation and coding scheme and redundancy version—5 bits
New data indicator—1 bit
TPC command for schedule PUSCH—2 bits
Cyclic shift for DMRS—3 bits
UL index—2 bits (this field is present only for TDD operation
with uplink-downlink configuration 0)
Downlink Assignment Index (DAI)—2 bits (this is present only for
TDD operation with uplink-downlink configurations 1-6)
CQI request—1 bit
Carrier Index Fiel (CIF)—3 bits (this field is present only
for Carrier Aggregation)
```

Referring to Table 2, the uplink grant is information corresponding to the format 0 of Downlink Control Information (DCI) transmitted on a PDCCH. The uplink grant includes pieces of information, such as RB, a Modulation and Coding Scheme (MCS), and TPC.

The UE checks the CCCIF indicative of a combinable CC, included in the CPHR request message. Accordingly, the UE is prepared to perform the CPH report on the combinable CC, requested by the eNB. That is, the UE calculates the CPH of the combinable CC indicated by the CCCIF at step S815. The CPH may be calculated using the method illustrating Equations 1 to 6. If the CCCIF indicates a plurality of combination CCs, the UE calculated the CPH of each of the plurality of combination CCs. Meanwhile, if a combination CC is {CC1, CC2, CC3}, uplink scheduling regarding the CC1 and the CC2 may exist, but uplink scheduling regarding the CC3 may do not exist. The CPH is calculated in preparation for future scheduling by the eNB although the CPH is not scheduled at present. Accordingly, the CPH is calculated on the basis of resources and an MCS level which are allocated to the CC3 by default or virtually.

The UE sends CPH information, including a CPHF, to the eNB at step S820. The CPH information may be configured in the form of a message generated in the MAC layer or in the form of a message generated in the RRC layer.

Here, the CPHF is a field indicating the CPH. The CPHF is a field included in an MAC CE. The LCID (Logical Channel ID) field of an MAC subheader may indicate that a relevant MAC CE is for a report on CPH.

The eNB performs uplink scheduling on the basis of the CPH information received from the UE at step S825.

In the series of processes, the CCCIF is transmitted by the eNB, and the CPH information is transmitted by the UE. In this case, both the CCCIF and the CPH information can be prevented from being concentrated in uplink or downlink.

Furthermore, since an eNB can selectively receive only a CPH report on a necessary CC, uplink resources unnecessary for an UE can be reduced. Furthermore, an UE may have less uplink signaling load because it does not necessary to inform an eNB that a CPH reported by the UE is related to what combination CC.

Hereinafter, pieces of signaling performed within the procedure of FIG. 8 are sequentially described in detail. First, the triggering conditions are described.

FIG. 9 is a flowchart illustrating an eNB triggering a report request according to an embodiment of the present invention. This report request triggering is called triggering according to the configuration/reconfiguration of a CC.

Referring to FIG. 9, the eNB configures or reconfigures a CC at step S900. In general, the eNB calculates uplink resources necessary for an UE by taking an SR (scheduling request) and BSR (buffer state report) information, received from the UE, into account. Furthermore, the eNB determines the number of CCs to be configured for the UE and a CC combination by taking resources now available for the eNB, a network policy, and so on into consideration.

For example, if the number of CCs to be configured for an UE is 3 and the CCs include a No. 1 CC to a No. 5 CC, an eNB may select three CCs from the five CCs and configure a CC combination, such as {CC1, CC2, CC3} or {CC1, CC3, CC5}, for the UE. However, an eNB may perform reconfiguration for changing the number of CCs configured for an UE, an index, a band, and a combination.

Accordingly, when the eNB instructs the configuration or reconfiguration of CCs regarding the UE, the UE configures or reconfigures the CCs. The configuration or reconfiguration of the CCs is instructed through an RRC connection establishment procedure, an RRC connection re-establishment procedure, or an RRC connection reconfiguration procedure.

When the CC is configured or reconfigured, the eNB triggers a CPH report at step S905. In the configuration of a CC, an eNB triggers a report request for all possible combination CCs. Meanwhile, the reconfiguration of a CC is performed when mapping between a logical CC index and a physical CC index is changed or the number of configured CCs is changed. Accordingly, an eNB triggers a report request for a changed combination CC.

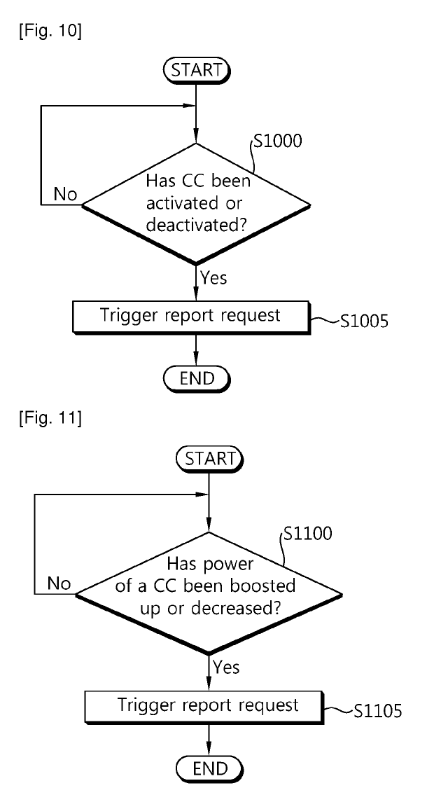

FIG. 10 is a flowchart illustrating an eNB triggering a report request according to another embodiment of the present invention. The report request triggering is called triggering by CC activation.

Referring to FIG. 10, the eNB determines whether there is a CC to which deactivation or activation has been applied at step S1000.

if, as a result of the determination, there is a CC to which deactivation or activation has been applied, the eNB triggers all combination CCs including the relevant CC at step S1005. For example, it is assumed that the combination CCs include {CC1, CC2}, {CC1, CC3}, {CC2, CC3}, and {CC1, CC2, CC3}.

For example, if a CC1 has been activated or deactivated, a CPH report request for combination CCs, including {CC1, CC2}, {CC1, CC3}, and {CC1, CC2, CC3} related to the CC1, is triggered. Next, if deactivation has been applied to a CC, a combination CC not including the deactivated CC will be reconfigured. If activation has been applied to a CC, a combination CC including the activated CC will be reconfigured.

FIG. 11 is a flowchart illustrating an eNB triggering a report request according to yet another embodiment of the present invention. This report request triggering is called triggering by power control.

Referring to FIG. 11, the eNB determines whether power of a CC is boosted up higher than a threshold or reduced lower than the threshold for the purpose of ICIC at step S1100. The ICIC means that power of a CC, becoming a cause of interference, is boosted up or reduced when the interference is generated because a plurality of cells performs communication using the same CC. Accordingly, power of a specific CC may be restricted by ICIC so that it is boosted up higher than a threshold or reduced lower than the threshold.

If, as a result of the determination, power of a CC is boosted up higher than the threshold or reduced lower than the threshold for ICIC, the eNB triggers a CPH report request for all combination CCs including the relevant CC at step S1105. If power of the CC is boosted up, a combination CC including the CC is added. On the other hand, if power of the CC is reduced, a combination CC excluding the CC is added.

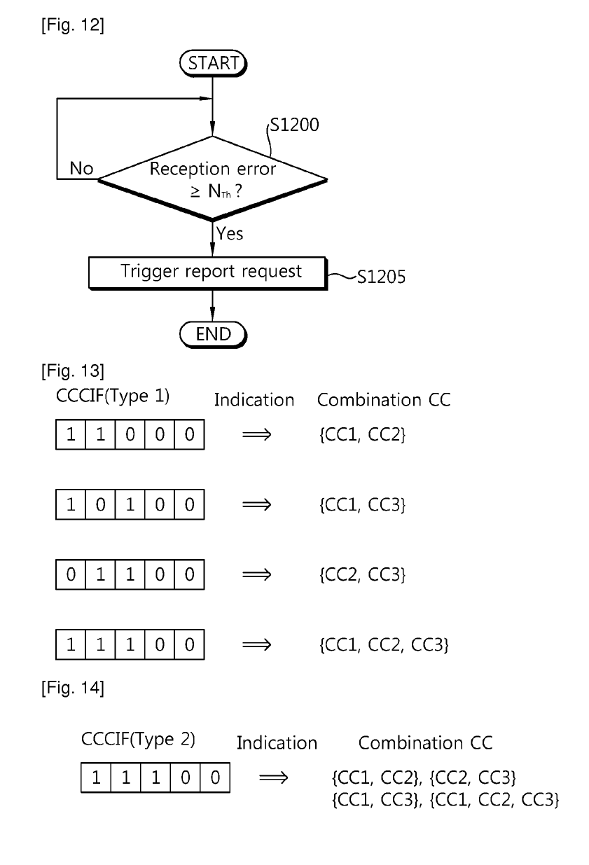

FIG. 12 is a flowchart illustrating an eNB triggering a report request according to further yet another embodiment of the present invention. This report request triggering is called error-induced triggering.

Referring to FIG. 12, the eNB determines whether there is a CC having the number of reception errors equal to or higher than a threshold N_{TH} at step S1200. If, as a result of the determination, there is a CC having the number of reception errors equal to or higher than the threshold, the eNB triggers a CPH report request regarding a combination CC including the relevant CC at step S1205. This is because an UE is determined not to bear power control of a target level in regard to scheduling for the CC. The reception error may be an error that induces the retransmission of a packet in HARQ (Hybrid Automatic Repeat reQest).

For example, if an error is generated after performing CRC (Cyclic Redundancy Check) for an HARQ packet, an eNB may increase the number of reception errors by 1. According to this method, if the number of accumulated reception errors is a threshold or higher, the eNB triggers a report request. If a power headroom report is received after the report request is triggered, the eNB resets the number of accumulated reception errors and waits for next report request triggering.

Hereinafter, a CPHR request message is described. As described above, the CPHR request message includes a CCCIF. The CCCIF indicates a combination CC, and it is classified into a CCCIF of Type 1 and a CCCIF of Type 2 according to a method of the CCCIF indicates the combination CC.

The CCCIF of Type 1 indicates a single combination CC.

The CCCIF of Type 1 may be a bitmap having the same number of bits as the number of aggregatable CCs. This is described in more detail with reference to FIG. 13.

FIG. 13 is a diagram showing a combination CC indication field according to an embodiment of the present invention. That is the combination CC indication field of Type 1 (CCCIF Type 1).

Referring to FIG. 13, it is assumed that aggregatable CCs are CC1, CC2, CC3, CC4, and CC5 and CCs configured in an UE are CC1, CC2, and CC3. In this case, the CCCIF of Type 1 is a bitmap having a 5-bit length. All possible combination CCs are four kinds of cases; {CC1, CC2}, {CC2, CC3}, {CC1, CC3}, and {CC1, CC2, CC3}. The CCCIF of Type 1 indicating {CC1, CC2} is 11000, the CCCIF of Type 1 indicating {CC2, CC3} is 01100, the CCCIF of Type 1 indicating {CC1, CC3} is 10100, and The CCCIF of Type 1 indicating {CC1, CC2, CC3} is 11100. That is, in the entire bitmap, only bits mapped to configured CCs are used, and bits mapped to the remaining CC4 and CC5 are 0. The sequence of the combination CCs is meaningless. That is, {CC1, CC2} and {CC2, CC1} are treated as the same combination CC.

A 1:1 mapping relationship is established between the CCCIF of Type 1 and a combination CC. That is, one CCCIF of Type 1 indicates one combination CC only. Accordingly, in order to request a CPH report on a plurality of combination CCs, an eNB has only to send a CPHR request message including a plurality of CCCIFs.

As another example of the CCCIF of Type1, the CCCIF of Type 1 includes that all the branches (cases) of combination CCs requiring a CPH report is represented by a bitmap having the same number of bits as the number of aggregatable CCs. In other words, the CCCIF of Type 1 has information (represented by bits) that indicates a specific one of combination CCs for which a CPH report is requested through the bitmap. Accordingly, the CCCIF of Type 1 consists of bits for representing the cases of the combination CCs.

For example, the CCCIF of Type 1 may have the number of bits capable of representing the number of all possible combination CCs. It is assumed that the number of all possible combination CCs for n aggregatable CCs is y. In this case, y=ₙC₂+ₙC₃+ . . . +ₙCₙ. Here, ₙCᵣ is a combination and

$$\frac{n !}{r ! ( n - r ) !} .$$

Accordingly, the length of the CCCIF of Type 1 is ceiling(log₂(y)). Here, ceiling(a) is a minimum integer greater than a. For example, it is assumed aggregatable CCs are CC1, CC2, and CC3. All possible combination CCs are four kinds of cases; {CC1, CC2}, {CC2, CC3}, {CC1, CC3}, and {CC1, CC2, CC3}. All the four kinds of cases may be represented by ceiling(log₂(4))=2 bits. Accordingly, if the CCCIF of Type 1 is 00, it may indicate {CC1, CC2}. If the CCCIF of Type 1 is 01, it may indicate {CC2, CC3}. If the CCCIF of Type 1 is 10, it may indicate {CC1, CC3}. If the CCCIF of Type 1 is 11, it may indicate {CC1, CC2, CC3}. The sequence of the combination CCs is meaningless. That is, {CC1, CC2} and {CC2, CC1} are treated as the same combination CC.

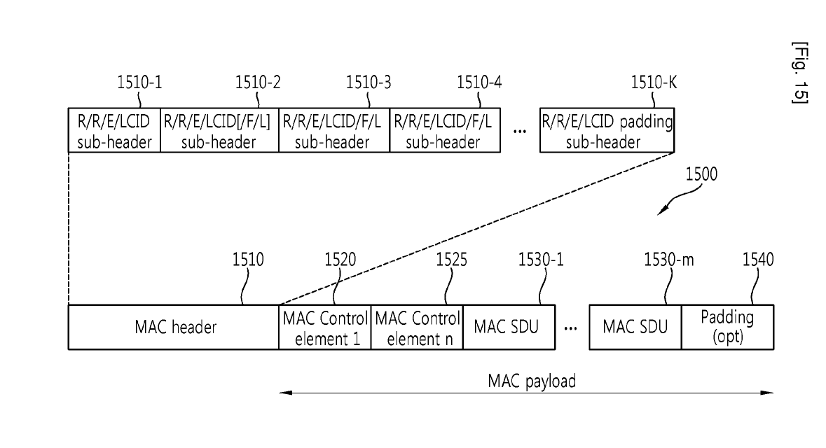

Next, the CCCIF of Type 2 indicates all combination CCs that are combined by a configured CC. This is described with reference to FIG. 14 below.

FIG. 14 is a diagram showing a CCCIF according to another embodiment of the present invention. This CCCIF corresponds to the CCCIF of Type 2.

Referring to FIG. 14, the CCCIF of Type 2 is a bitmap having the same number of bits as the number of all aggregatable CCs. Each bit of the bitmap is mapped to a specific CC. If a specific bit is 1, the CCCIF of Type 2 indicates all CC combinations in which a CC mapped to the specific bit is taken into account.

For example, it is assumed that the number of all aggregatable CCs is 5 and CCs configured for an UE are CC1, CC2, and CC3. If the CCCIF of Type 2 is represented by ‘11100’, the CCCIF of Type 2 indicates all {CC1, CC2}, {CC2, CC3}, {CC1, CC3}, and {CC1, CC2, CC3} which are all combination CCs that may be combined by CC1, CC2, and CC3. That is, all combination CCs can be represented by the CCCIF of Type 2. Accordingly, 1: m mapping relationship is established between the CCCIF of Type 2 and the combination CC.

Accordingly, in order to request a CPH report on a plurality of combination CCs, an eNB has only to send a CPHR request message, including only the CCCIF of Type 2, to an UE.

Here, the CCCIF of Type 1 and the CCCIF of Type 2 has the following trade-off relationship.

The CCCIF of Type 1 requires the same number of CCCIFs as the number of combination CCs in order to indicate a variety of combination CCs, but may indicate only a specific combination CC. On the other hand, the CCCIF of Type 2 may represent various cases of combination CCs through one bitmap signaling, but cannot indicate only specific single combination CC. In order to indicate only a relatively small number of single combination CCs, the CCCIF of Type 1 may be efficient. In order to indicate a relatively large number of single combination CCs, the CCCIF of Type 2 may be efficient.

One of the two kinds of the CCCIFs may be used and both the two kinds of the CCCIFs may be used in combination. In the later case, a type distinguishment indicator for distinguishing the CCCIF of Type 1 and the CCCIF of Type 2 from each other is required. The type distinguishment indicator may be a 1 bit indicator.

In relation to the properties of a CPHR request message, for example, the CPHR request message may be a control message generated in the RRC layer. That is, the CPHR request message is transmitted from an eNB to an UE through RRC signaling. For another example, the CPHR request message may be a control message generated in the MAC layer.

FIG. 15 shows the architecture of an MAC PDU including a CPHR request message according to an embodiment of the present invention. The MAC PDU is also called a Transport Block (TB).

Referring to FIG. 15, the MAC PDU 1500 includes an MAC header 1510, one or more MAC CEs 1520 to 1525, one or more MAC SDUs (Service Data Units) 1530-1 to 1530-m, and padding 1540.

The MAC CEs 1520 to 1525 are control messages generated in the MAC layer.

The MAC SDUs 1530-1 to 1530-m are the same as RLC PDUs transferred by the RLC layer. The padding 1540 is a specific number of bits which are added to the make the size of the MAC PDU constant. The MAC CEs 1520 to 1525, the MAC SDUs 1530-1 to 1530-m, and the padding 1540 are collectively called an MAC payload.

The MAC header 1510 includes one or more subheaders 1510-1, 1510-2 to 1510-k. The subheaders 1510-1, 1510-2 to 1510-k correspond to one MAC SDU, one MAC CE, or padding. The sequence of the subheaders 1510-1, 1510-2 to 1510-k is the same as that of the MAC SDUs the MAC CEs, or the paddings corresponding within the MAC PDU 1500.

Each of the subheaders 1510-1, 1510-2 to 1510-k may include four fields; R, R, E, and LCID fields or may include 6 fields; R, R, E, LCID, F, and L fields. The subheader including the four fields is a subheader corresponding to the MAC CE or the padding, and the subheader including the six fields is a subheader corresponding to an MAC CE or an MAC SDU consisting of one or more octets.

The Logical Channel ID (LCID) field is an ID field for identifying a logical channel, corresponding to an MAC SDU, or for identifying the type of an MAC CE or padding and may be 5 bits.

For example, the LCID field is mapped to an MAC CE, and it indicates the type or function of the mapped MAC CE. For example, the LCID field identifies whether a mapped MAC CE is for a CPHR request, an IPHR request, or an CPHR, whether the mapped MAC CE is for a feedback request MAC CE requesting feedback information from an UE, whether the mapped MAC CE is for a DRX (Discontinuous Reception) command MAC CE regarding a non-continuous reception command, or whether the mapped MAC CE is for a contention solution identity MAC CE for a contention solution between UEs in a random access procedure. One LCID field exists for each of the MAC SDU, the MAC CE, and the padding. Table 3 is an example of the LCID field.

TABLE 3

| Index | LCID values |
|---|---|
| 00000 | CCCH |
| 00001-01010 | Identity of logical channel |
| 01011-10101 | Reserved |
| 10110 | UL activation/deactivation |
| 10111 | DL activation/deactivation |
| 11000 | Reference CC Indicator |
| 11001 | IPHR request |
| 11010 | CPHR request |
| 11011 | C-RNTI |
| 11100 | Truncated BSR |
| 11101 | Short BSR |
| 11110 | Long BSR |
| 11111 | Padding |

Referring to Table 3, if the LCID field is 11001, it means that a relevant MAC CE indicates an MAC CE for an IPHR request. If the LCID field is 11510, it means that a relevant MAC CE is for an MAC CE for a CPHR request.

The L field is a field indicative of the length of a relevant MAC SDU. One L field exists for one MAC SDU included in an MAC PDU. The E field is an extension field, indicating whether an LCID field or an L field additional to a subheader exists. If the E field is set to 1, it means that another LCID field, another L field, and a set of E fields follow the E field. If the E field is set to 0, it means that an MAC payload follows the E field. The R field is the remaining redundant bits.

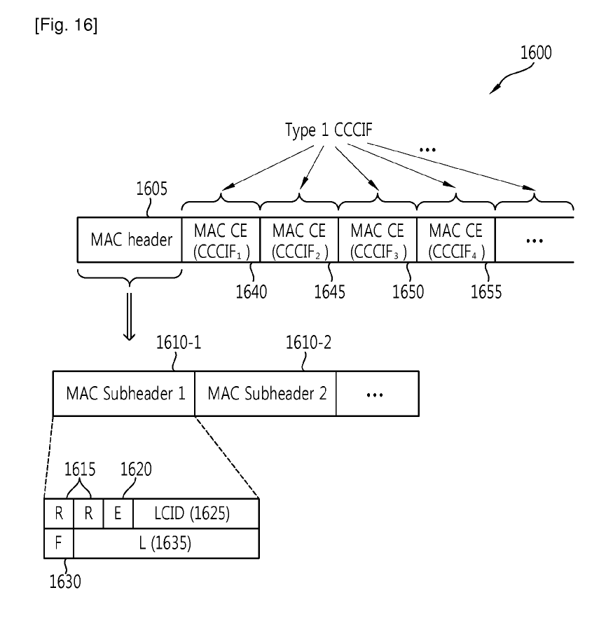

FIG. 16 shows the architecture of an MAC PDU including a CPHR request message according to another embodiment of the present invention. The CPHR request message is a CPHR request message according to the CCCIF of Type 1.

Referring to FIG. 16, the MAC PDU 1600 including the CPHR request message includes an MAC header 1605 and a plurality of MAC CEs 1640, 1645, 1650, 1655, . . . . The plurality of MAC CEs 1640, 1645, 1650, 1655, . . . is CPH information.

The MAC header 1605 includes an MAC subheader1 1610-1, an MAC subheader2 1610-2, . . . . The MAC subheader1 1610-1 includes two R fields 1615, an E field 1620, an LCID field 1625, an F field 1630, and an L field 1635. The L field 1635 indicates the length of the plurality of consecutive MAC CEs 1640, 1645, 1650, 1655, . . . for a CPH report request. The LCID field 1625 is indicated by 11010 according to Table 3.

The plurality of MAC CEs 1640, 1645, 1650, 1655, . . . include a first CCCIF CCCIF₁, a second CCCIF CCCIF₂, a third CCCIF CCCIF₃, a fourth CCCIF CCCIF₄, . . . , respectively.

If both the CCCIFs of Type 1 and Type 2 are mixed and used, a type distinguishment indicator for distinguishing the CCCIF of Type 1 and the CCCIF of Type 2 from each other is required. The type distinguishment indicator is a 1 bit indicator and may be included in the R fields 1615.

The CPHR request message of FIG. 16 indicates that at least one CCCIF of Type 1 may exist within the CPHR request message, but the present invention is not limited thereto.

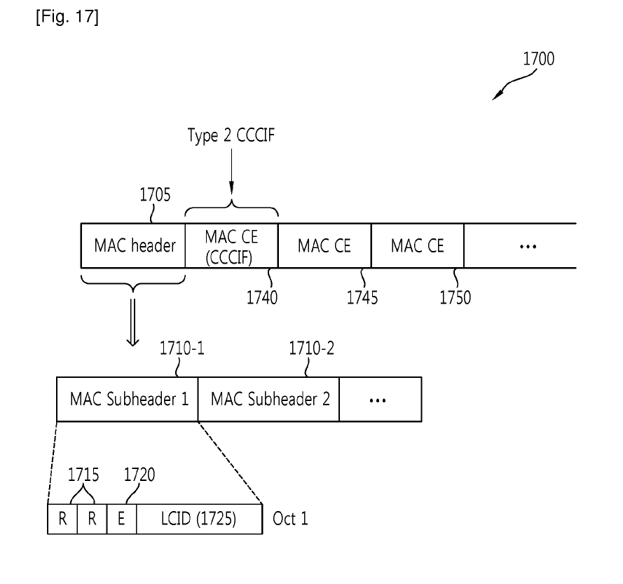

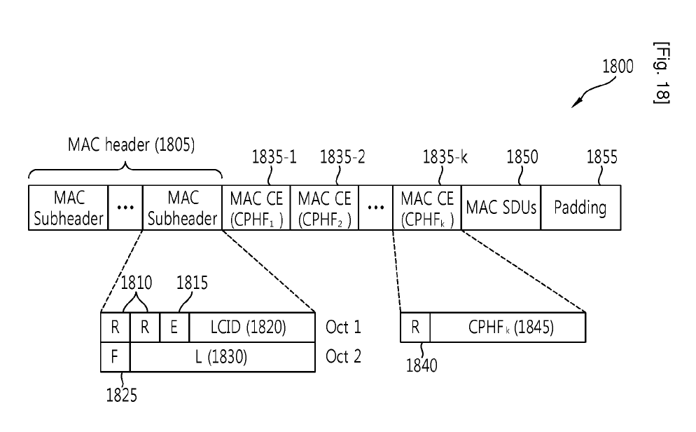

FIG. 17 shows the architecture of an MAC PDU including a CPHR request message according to yet another embodiment of the present invention. The CPHR request message is a CPHR request message according to the CCCIF of Type 2.

Referring to FIG. 17, the MAC PDU 1700 including the CPHR request message includes an MAC header 1705 and a plurality of MAC CEs 1740, 1745, 1750, . . . . The plurality of MAC CEs 1740, 1745, 1750, 1755, . . . is part of the CPHR request message.

The MAC header 1705 includes an MAC subheader1 1710-1, an MAC subheader2 1710-2, . . . . The MAC subheader1 1710-1 includes two R fields 1715, an E field 1720, an LCID field 1725. The LCID field 1725 is indicated by 11010 according to Table 3.

If both the CCCIFs of Type 1 and Type 2 are mixed and used, a type distinguishment indicator for distinguishing the CCCIF of Type 1 and the CCCIF of Type 2 from each other is required. The type distinguishment indicator is a 1 bit indicator and may be included in the R fields 1715.

Only one MAC CE 1740 includes the CCCIF of Type 2, and the remaining MAC CEs 1745, 1750, . . . do not include the CCCIF of Type 2 CCCIF. This is because a number of combination CCs can be indicated by only one CCCIF of Type 2. Of course, if a CPH report on various CCS for an eNB is required, the plurality of MAC CEs 1740, 1745, 1750, . . . may include CCCIFs having different values.

For example, assuming that a first CCCIF CCCIF₁ is 11001 and a second CCCIF CCCIF₂ is 01110, combination CCs indicated by the first CCCIF may be {CC1, CC2}, {CC1, CC5}, {CC2, CC5}, and {CC1, CC2, CC5} and combination CCs indicated by the second CCCIF may be {CC2, CC3}, {CC2, CC4}, {CC3, CC4}, and {CC2, CC3, CC4}.

That is, a CPHR request message has a structure in which one or more CCCIFs of Type 2 are consecutively arranged over the plurality of MAC CEs 1740, 1745, 1750, . . . . Meanwhile, a rule for the sequence of arranged CPHFs may be different according to implementations, but a rule known to an eNB and an UE is regulated by agreement. For example, a CC having the smallest index and a combination CC having the next smallest index sequence may be sequentially arranged.

The arrangement of the CCCIFs in FIG. 17 indicates that one CCCIF of Type 2 may exist in the MAC PDU, but the present invention is not limited thereto.

The CCCIF of Type 1 and the CCCIF of Type 2 may be operated as separate MAC PDUs as in FIGS. 16 and 17 or may be mixed and operated within one MAC PDU. For example, assuming that an MAC PDU includes first and second MAC CEs, the first MAC CE may include the CCCIF of Type 1 and the second MAC CE may include the CCCIF of Type 2.

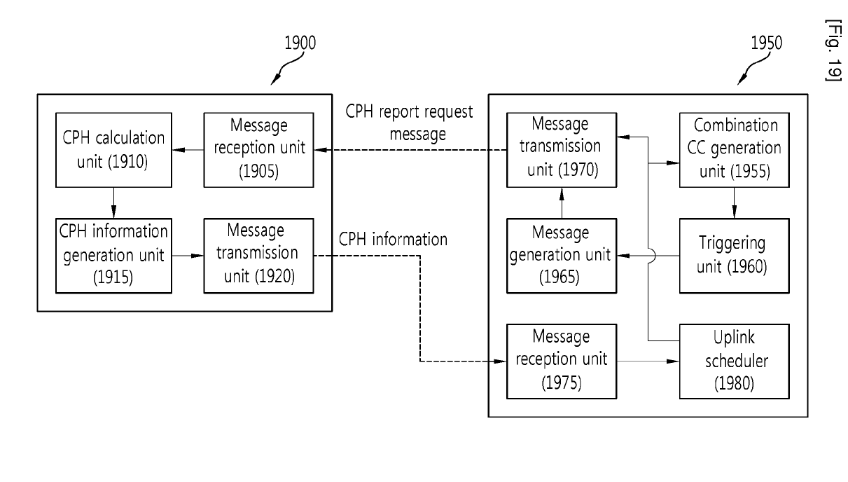

FIG. 18 is a block diagram showing an MAC PDU including CPH information according to an embodiment of the present invention. The CPH information includes an LCID field within an MAC subheader and a CPHF within an MAC CE.

Referring to FIG. 18, the MAC PDU 1800 includes an MAC header MAC header 1805, MAC CEs 1835-1, 1835-2, . . . 1835-k, an MAC SDUs 1850, and padding 1855.

The MAC header 1805 includes an i number of MAC subheaders 1805-1, . . . , 1805-i. The MAC subheaders 1805-i include R fields 1810, an E field 1815, an LCID field 1820, an F field 1825, and an L field 1830. The LCID field 1820 is shown in Table 4 below.

TABLE 4

| Index | LCID values |
|---|---|
| 00000 | CCCH |
| 00001-01010 | Identity of logical channel |
| 01011-10011 | Reserved |
| 10100 | UL activation/deactivation |
| 10101 | DL activation/deactivation |
| 10110 | Reference CC Indicator |
| 10111 | IPHR request |
| 11000 | CPHR request |
| 11001 | IPHR |
| 11010 | CPHR |
| 11011 | C-RNTI |
| 11100 | Truncated BSR |
| 11101 | Short BSR |
| 11110 | Long BSR |
| 11111 | Padding |

Referring to Table 4, when the LCID field 1820 is 11001, it means that a relevant MAC CE is an MAC CE for an IPH report (IPHR). Here, the relevant MAC CE includes an IPH field (IPHF). Meanwhile, when the LCID field 1820 is 11010, it means that a relevant MAC CE is an MAC CE for a CPH report (CPHR). Here, the relevant MAC CE includes a CPHF.

The L field 1830 is a field, indicating the length of relevant MAC CEs 1835-1, 1835-2, . . . 1835-k in the form of the number of bits. The E field 1815 is an extension field indicating whether an additional LCID field and an additional L field exist in the MAC subheaders 1805-1, . . . , 1805-i. The R field 1810 is redundant bits in the MAC subheader 1805-i.

Meanwhile, each of the MAC CEs 1835-1, 1835-2, . . . , 1835-k includes a CPHF. For example, the MAC CE 1835-1 may include a first CPHF CPHF₁, the MAC CE 1835-2 may include a second CPHF CPHF₂, and the MAC CE 1835-k may include an R field 1840 and a k^{th} CPHF CPHFₖ 1845. CPH indicated by each CPHF may be defined within a range, such as that shown in Table 1.

Here, the sequence of the CPHFs disposed within the MAC PDU 1800 is not necessarily fixed. However, an UE and an eNB must know the sequence in which a plurality of CPHFs is disposed within one MAC PDU 1800.

For example, it is assumed that an eNB has made a CPHR request by sending a CPHR request message to an UE.

It is also assumed that the CPHR request message includes CCCIFs 1, 2, and 3 of Type 1 and the CCCIFs 1, 2, and 3 of Type 1 indicate a first combination CC, a second combination CC, and a third combination CC, respectively. The UE calculates a first CPH regarding the first combination CC, a second CPH regarding the second combination CC, and a third CPH regarding the third combination CC and generates a first CPHF, a second CPHF, and a third CPHF indicating the first CPH, the second CPH, and the third CPH, respectively. Furthermore, the UE generates a first MAC CE, a second MAC CE, and a third MAC CE, including the first, the second, and the third CPHFs, respectively, and finally configures an MAC PDU.

The UE configures the MAC PDU so that the first MAC CE, the second MAC CE, and the third MAC CE are disposed according to the sequence also known to the eNB. Alternatively, the CPHFs may be disposed according to the same sequence as the sequence of implicitly corresponding CCCIFs. For example, the UE may configure the MAC PDU so that the first MAC CE, the second MAC CE, and the third MAC CE are disposed in this order. If the sequence of the CPHFs disposed within the MAC PDU is not previously agreed between the eNB and the UE, the UE must additionally inform the eNB of an indicator, indicating that each CPHF indicates what combination CC, through signaling. In other word, an MAC CE including the indicator may be added to the MAC PDU.

The same is true when the eNB sends a CPHR request message, including the CCCIF of Type 2, to an UE. That is, when generating CPH information about at least one combination CC indicated by the CCCIF of Type 2, the UE may dispose CPHFs within an MAC PDU according to a specific combination CC sequence agreed with the eNB.

FIG. 19 is a block diagram showing an apparatus for transmitting and receiving CPH information according to an embodiment of the present invention.

Referring to FIG. 19, the apparatus 1900 for transmitting CPH information includes a message reception unit 1905, a CPH calculation unit 1910, a CPH information generation unit 1915, and a message transmission unit 1920.

The message reception unit 1905 receives an uplink grant and a CPHR request message from an apparatus 1950 for receiving CPH information. An example of the uplink grant is shown in Table 2. The CPHR request message may be an MAC PDU including CCCIFs, as described above with reference to FIGS. 16 and 17, and may be an RRC message generated in the RRC layer.

The CPH calculation unit 1910 calculates CPH regarding a combination CC indicated by a CCCIF. The CPH may be calculated according to Equation 1 to Equation 6.

The CPH information generation unit 1915 generates CPH information on the basis of the CPH calculated by the CPH calculation unit 1910. The CPH information includes a CPHF. A value of the CPHF may be found on the basis of Table 1. The CPHF is included in an MAC PDU.

The CPH information transmission unit 1920 sends the CPH information, generated by the CPH information generation unit 1915, to the apparatus 1950 for receiving CPH information in the form of an RRC message or an MAC message on the basis of the uplink grant received by the message reception unit 1905.

The apparatus 1950 for receiving CPH information includes a combination CC generation unit 1955, a triggering unit 1960, a message generation unit 1965, a message transmission unit 1970, a message reception unit 1975, and an uplink scheduler 1980.

The combination CC generation unit 1955 generates all possible case of combination CCs or combination CCs requiring a CPH report on the basis of a CC configured in the apparatus 1900 for transmitting CPH information. For example, if the configuration of a CC is changed, the combination CC generation unit 1955 may generate all possible cases of combination CCs. Alternatively, the combination CC generation unit 1955 may generate only a necessary combination CC according to whether a plurality of CCs has been implemented in different RF chains.

The triggering unit 1960 determines whether a condition that triggers a CPHR request regarding a combination CC generated by the combination CC generation unit 1955 is satisfied. The triggering method may include triggering by CC configuration/reconfiguration, triggering by CC activation/deactivation, triggering by power control, and error-induced triggering, as described above with reference to FIGS. 9 to 12. The triggering unit 1960 may apply the triggering methods independently or using a method of combining two or more of the triggering methods.

If the triggering unit 1960 determines that the triggering condition is satisfied, the message generation unit 1965 generates a CPHR request message including a CCCIF indicating the combination CC. The CCCIF may be configured according to the architecture of an MAC PDU, such as that shown in FIGS. 16 and 17, or may be configured in the form of an RRC message.

The message transmission unit 1970 sends the CPHR request message, generated by the message generation unit 1965, to the apparatus 1900 for transmitting CPH information. Furthermore, the message transmission unit 1970 sends an uplink grant, generated by the uplink scheduler 1980, to the apparatus 1900 for transmitting CPH information.

The message reception unit 1975 receives CPH information from the apparatus 1900 for transmitting CPH information.

The uplink scheduler 1980 performs dynamic uplink scheduling within a range in which the limit of the maximum transmission power of the apparatus 1900 for transmitting CPH information in uplink is not exceed on the basis of the CPH information received from the message reception unit 1975. Furthermore, the uplink scheduler 1980 generates the uplink grant and sends it to the message transmission unit 1970.

While some exemplary embodiments of the present invention have been described with reference to the accompanying drawings, those skilled in the art may change and modify the present invention in various ways without departing from the essential characteristic of the present invention. Accordingly, the disclosed embodiments should not be construed to limit the technical spirit of the present invention, but should be construed to illustrate the technical spirit of the present invention. The scope of the technical spirit of the present invention is not restricted by the embodiments, but should be interpreted based on the following claims. Accordingly, all technical spirits within an equivalent range should be interpreted as being included in the scope of the present invention.

1. A method of an user equipment (UE) transmitting power headroom information in a multiple component carrier system, the method comprising:
receiving a Combination Power Headroom Report (CPHR) request message from a eNodeB (eNB);
calculating a Combination Power Headroom (CPH) of power headrooms for a plurality of component carriers, indicated by a combination indication field of the CPHR request message, by checking the combination indication field; and
sending a message including the calculated CPH, to the eNB.

2. The method of claim 1, further comprising receiving an uplink grant for allocating uplink scheduling for the UE, from the eNB, before calculating the CPH,
wherein the message including the CPH is transmitted using uplink resources allocated by the uplink grant.

3. The method of claim 1, wherein the combination indication field of the CPHR request message comprises at least one of bitmap information to indicate a single combination, information to indicate a specific case of cases of a number of single combinations represented by the bitmap, and information to indicate a plurality of combinations.

4. The method of claim 3, wherein the CPHR request message is composed of a Medium Access Control Protocol Data Unit (MAC PDU).

5. The method of claim 1, wherein the message including the CPH is composed of a MAC PDU including the one or more calculated CPHs consecutive to each other.

6. The method of claim 5, wherein:
the MAC PDU comprises an MAC subheader and an MAC control element,
the MAC control element comprises the one or more CPHs, and
the MAC subheader comprises a Logical Channel ID (LCID) indicating that the MAC control element is for transmitting the CPH information.

7. The method of claim 1, wherein the CPHR request message or the message including the calculated CPH comprises a Radio Resource Control (RRC) message generated in an RRC layer.

8. A method of an eNodeB eNB1 receiving power headroom information in a multiple component carrier system, the method comprising:
sending a Combination Power Headroom Report (CPHR) request message, including a combination indication field, to an user equipment (UE1; and
receiving a response message including a Combination Power Headroom (CPH1 calculated based on the combination indication field, from the UE,
wherein the combination indication field indicates a combination including a plurality of component carriers, and the CPH comprises information about power headrooms calculated in the UE-specific way upon uplink transmission through the plurality of component carriers.

9. The method of claim 8, further comprising sending an uplink grant for allocating uplink scheduling for the UE, to the UE, before sending the CPHR request message,
wherein the CPH information is received using uplink resources allocated by the uplink grant.

10. The method of claim 8, wherein:
the combination indication field is a bitmap for mapping each of all the component carriers allocated to the UE, to a bit at a specific position, and
the bitmap indicates the plurality of component carriers.

11. The method of claim 8, wherein the combination indication field is one of a bitmap for exclusively mapping each of all the component carriers allocated to the UE to a bit at a specific position and information to indicate all cases of combinations produced by the component carriers indicated in the bitmap.

12. The method of claim 8, further comprising performing report request triggering, before sending the CPHR request message,
wherein the report request triggering is an operation entering a state in which the eNB is able to request the CPH report.

13. The method of claim 12, wherein the report request triggering is performed when at least one of the plurality of component carriers is reconfigured in the UE.

14. The method of claim 12, wherein the report request triggering is performed when at least one of the plurality of component carriers is activated or deactivated.

15. The method of claim 12, wherein the report request triggering is performed when power of a specific component carrier of the plurality of component carriers is boosted up higher than a preset threshold or reduced lower than the preset threshold.

16. The method of claim 12, wherein the report request triggering is performed when reception errors by the UE through a specific component carrier of the plurality of component carriers are equal to higher than a predetermined threshold.

17. An apparatus for transmitting power headroom information in a multiple component carrier system, the apparatus comprising:
a message reception unit for receiving a Combination Power Headroom Report (CPHR) request message, including a combination indication field indicative of a combination including a plurality of component carriers, from an eNodeB eNB1;
a Combination Power Headroom (CPH), calculation unit for calculating a CPH of power headrooms, calculated upon uplink transmission through component carriers indicated by the combination indication field of the CPHR request message, by checking the combination indication field; and
a message transmission unit for generating a message, including CPH information, and sending the generated message to the eNB,
wherein whether the combination indication field is composed of any one form of bitmap information to indicate a single combination, information to indicate a specific case of cases of a number of single combinations represented by the bitmap, and information to indicate a plurality of the combinations is checked.

18. An apparatus for receiving power headroom information in a multiple component carrier system, the apparatus comprising:
a triggering unit for determining whether a triggering condition to induce a report request for power headrooms for a plurality of component carriers is satisfied;
a message transmission unit for sending a Combination Power Headroom Report (CPHR) request message, including information about a combination including the plurality of component carriers, to an user equipment (UE), if the triggering condition is satisfied;
a message reception unit for receiving a response message, including Combination Power Headroom (CPH1 information calculated based on the information about the combination, from the UE; and
an uplink scheduler for performing dynamic uplink scheduling for the UE with reference to the CPH information of the response message,
wherein the CPHR request message comprises a combination indication field, indicating the combination of the plurality of component carriers, in at least one form of bitmap information to indicate a single combination, information to indicate a specific case of cases of a number of single combinations represented by the bitmap, and information to indicate a plurality of combinations.
